(19) United States
(12) Patent Application Publication
(10) Pub. No.: US 2018/0052664 A1
(43) Pub. Date: Feb. 22, 2018

(54) METHOD AND SYSTEM FOR DEVELOPING, TRAINING, AND DEPLOYING EFFECTIVE INTELLIGENT VIRTUAL AGENT

(71) Applicant: Rulai, Inc., Los Altos, CA (US)

(72) Inventors: Yi Zhang, Saratoga, CA (US); Roger Jin, Los Altos, CA (US); Yunfei Chen, Cupertino, CA (US); Xing Yi, Milpitas, CA (US); Yueming Sun, San Jose, CA (US)

(21) Appl. No.: 15/600,251

(22) Filed: May 19, 2017

Related U.S. Application Data
(60) Provisional application No. 62/375,765, filed on Aug. 16, 2016.

(51) Int. Cl. G06F 9/44; G06F 3/0482; G06F 3/0486; G10L 15/18; G06F 17/30; G10L 15/08

(52) U.S. Cl. CPC G06F 8/34; G06F 3/0482; G06F 3/0486; G06N 99/005; G06F 17/30654; G10L 15/08; G10L 15/1822

(57) ABSTRACT

The present teaching relates to developing a virtual agent. In one example, a plurality of graphical objects is presented to a user via a bot design programming interface. Each of the plurality of graphical objects represents a module corresponding to an action to be performed by the virtual agent. One or more inputs from the user are received, via the bot design programming interface, for selecting a set of graphical objects from the plurality of graphical objects. The one or more inputs provide information of a first order of the set of graphical objects. A plurality of modules represented by the set of graphical objects is identified. Based on the one or more inputs, a second order of the plurality of modules is determined based on the first order. The plurality of modules is integrated in the second order to generate a customized virtual agent for executing an associated task according to the second order.

### CROSS REFERENCE TO RELATED APPLICATION

This application claims priority from the U.S. provisional Application 62/375,765 filed Aug. 16, 2016, which is hereby expressly incorporated by reference in its entirety.

### BACKGROUND

### 1. Technical Field

The present teaching generally relates to online services. More specifically, the present teaching relates to methods, systems, and programming for developing a virtual agent that can have a dialog with a user.

### 2. Technical Background

With the new wave of Artificial Intelligence (AI), some research effort has been directed to conversational information systems. Intelligent assistant or so called intelligent bot has emerged in recent years. Examples include Siri® of Apple, Facebook Messenger, Amazon Echo, and Google Assistant.

Conventional chat bot systems require many hand written rules and many manually labelled training data for the systems to learn the communication rules for each specific domain, which requires expensive human-labeling efforts. In addition, developers of conventional chat bot systems are required to write and debug source codes themselves. There is no friendly and consistent interface for developers to design and customize virtual agents to meet their own specific needs, which causes each developer to face a long learning curve when developing a new virtual agent.

Therefore, there is a need to provide an improved solution for development and application of a virtual agent to solve the above-mentioned problems.

### SUMMARY

The teachings disclosed herein relate to methods, systems, and programming for online services. More particularly, the present teaching relates to methods, systems, and programming for developing a virtual agent that can have a dialog with a user.

In one example, a method implemented on a computer having at least one processor, a storage, and a communication platform for developing a virtual agent is disclosed. According to the method for developing a virtual agent, a plurality of graphical objects is presented to a developer user, wherein each of the plurality of graphical objects represents a module which, once executed, performs an action. Then one or more inputs are received from the developer user that selects a set of graphical objects from the plurality of graphical objects and provides information about an order in which the set of graphical objects is organized. A set of modules are identified that are represented by the set of graphical objects. The set of modules are then integrated in the order to generate the virtual agent which, when deployed, performs actions corresponding to the set of modules in the order.

In a different example, a system for developing a virtual agent is disclosed to comprise a bot design programming interface manager, a virtual agent module determiner, and a visual input based program integrator. The bot design programming interface manager is configured for presenting, via a bot design programming interface, a plurality of graphical objects to a developer user, wherein each of the plurality of graphical objects represents a module which, once executed, performs an action and receiving, via the bot design programming interface, one or more inputs from the developer user that selects a set of graphical objects from the plurality of graphical objects and provides information about an order in which the set of graphical objects is organized. The virtual agent module determiner is configured for identifying a set of modules represented by the set of graphical objects and the visual input based program integrator is configured for integrating the set of modules in the order to generate the virtual agent which, when deployed, performs actions corresponding to the set of modules in the order.

Other concepts relate to software for implementing the present teaching on developing a virtual agent. A software product, in accord with this concept, includes at least one machine-readable non-transitory medium and information carried by the medium. The information carried by the medium may be executable program code data, parameters in association with the executable program code, and/or information related to a user, a request, content, or information related to a social group, etc.

In one example, machine readable non-transitory medium is disclosed, wherein the medium has information for developing a virtual agent recorded thereon so that the information, when read by the machine, causes the machine to perform various steps. First, a plurality of graphical objects is presented to a developer user, wherein each of the plurality of graphical objects represents a module which, once executed, performs an action. Then one or more inputs are received from the developer user that selects a set of graphical objects from the plurality of graphical objects and provides information about an order in which the set of graphical objects is organized. A set of modules are identified that are represented by the set of graphical objects. The set of modules are then integrated in the order to generate the virtual agent which, when deployed, performs actions corresponding to the set of modules in the order.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts a framework of service agents development and application, according to an embodiment of the present teaching;

FIG. 1B illustrates exemplary service virtual agents, according to an embodiment of the present teaching;

FIG. 1C is a flowchart of an exemplary process for service agent development and application, according to an embodiment of the present teaching;

FIG. 2 depicts an exemplary high level system diagram of a service virtual agent, according to an embodiment of the present teaching;

FIG. 3 is a flowchart of an exemplary process of a service virtual agent, according to an embodiment of the present teaching;

FIG. 4 depicts an exemplary high level system diagram of a dynamic dialog state analyzer in a service virtual agent, according to an embodiment of the present teaching;

FIG. 5 is a flowchart of an exemplary process for a dynamic dialog state analyzer in a service virtual agent, according to an embodiment of the present teaching;

FIG. 6 depicts an exemplary high level system diagram of an agent re-router in a service virtual agent, according to an embodiment of the present teaching;

FIG. 7 is a flowchart of an exemplary process of an agent re-router in a service virtual agent, according to an embodiment of the present teaching;

FIG. 8 illustrates an exemplary user interface during a dialog between a service virtual agent and a chat user, according to an embodiment of the present teaching;

FIG. 9 illustrates an exemplary user interface during dialogs between a service virtual agent and multiple chat users, according to an embodiment of the present teaching;

FIG. 10 depicts an exemplary high level system diagram of a virtual agent development engine, according to an embodiment of the present teaching;

FIG. 11 is a flowchart of an exemplary process of a virtual agent development engine, according to an embodiment of the present teaching;

FIG. 12 illustrates an exemplary bot design programming interface for a developer to input conditions for triggering a dialog between a service virtual agent and a chat user, according to an embodiment of the present teaching;

FIG. 13A illustrates an exemplary bot design programming interface for a developer to select modules of a service virtual agent, according to an embodiment of the present teaching;

FIG. 13B illustrates an exemplary bot design programming interface through which a developer selects some parameter for a module of a service virtual agent, according to an embodiment of the present teaching;

FIG. 13C illustrates an exemplary bot design programming interface through which a developer modifies some parameter for a module of a service virtual agent, according to an embodiment of the present teaching;

FIG. 14 is a high level depiction of an exemplary networked environment for development and applications of service virtual agents, according to an embodiment of the present teaching;

FIG. 15 is a high level depiction of another exemplary networked environment for development and applications of service virtual agents, according to an embodiment of the present teaching;

FIG. 16 depicts the architecture of a mobile device which can be used to implement a specialized system incorporating the present teaching; and

FIG. 17 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present disclosure generally relates to systems, methods, medium, and other implementations directed to developing, training, and deploying effective intelligent virtual agents. In different embodiments, the present teaching discloses a virtual agent that can have a dialog with a user, based on a bot design programming interface. Many services heavily reply on human service representatives and human agents to address information needs from their customers or users, such as answering their questions and providing related information, helping customers to perform certain account management tasks, finding customer interests and making different types of recommendations for products, services and information, etc., in a timely manner through real-time online dialogue systems on different platforms (such as Mobile and Desktop), in order to better serve their customers/users and achieve better customer satisfaction. In order to effectively reduce the human labor and cost of those services which offer and maintain the above real-time online customer/user service dialogue systems, the present teaching discloses methods for designing and developing intelligent virtual agents, which can automatically generate and recommend response/reply messages for assisting human representatives or acting as virtual representatives/agents to communicate with customers in a more efficient and effective way, to achieve similar or even better customer satisfaction with minimum human involvement.

The present teaching can enable online dialogue systems to generate high quality responses by effectively leveraging and learning from different types of information via different technologies, including artificial intelligent (AI), natural language processing (NLP), ranking based machine learning, personalized recommendation and user tagging, multimedia sentimental analysis and interaction, and reinforcement based learning. For example, the key information utilized may include: (1) natural language conversation history/data logs from all users, (2) conversation contextual information such as the conversation history of a current session, the time and the location of the conversation, (3) the current user's profile, (4) knowledge specific with respect to each different service as well as each specific industry domain, (5) knowledge about internal or external third party informational services, (6) user click history and user transaction history, as well as (7) knowledge about customized conversation tasks.

The disclosed system in the present teaching can integrate various intelligent components into one comprehensive online dialogue system to generate high-quality automatic responses for effectively assisting human representatives/agents to accomplish complex service tasks and/or address customer's information need in an efficient way. More specifically, based on machine learning and AI technique, the disclosed system can learn how to strategically ask user questions, present intermediate candidates to the users based on historical human-human or human-machine or machine-machine conversation data, together with human or machine action data that involves calling third party applications, services or databases. The disclosed system can also learn and build/enlarge high quality answer knowledge base by identifying important frequent questions from historical conversational data and proposing new identified FAQs and their answers to be added to the knowledge base, which may be reviewed by human agents. The disclosed system can use the knowledge base and historical conversations for recommending high quality response messages for future conversation. The present teaching has disclosed both statistical learning and template based approach as well as deep learning models (e.g. a sequence to sequence language generation model, a sequence to structured data generation model, a reinforcement learning model, a sequence to user intention model) for generating higher quality and better utterance/response messages for the conversation and interaction. Moreover, the disclosed system can provide more effective products/services recommendations in the conversation by using not only user transaction history and user demographic information that are normally used in traditional recommendation engines, but also additional contextual information about the user needs, such as possible user initial request (i.e. a user query) or supplemental information collected while talking with the user. The disclosed system is also capable of using those information as well as users' implicit feedback signals (such as clicks and conversions) when interacting with our recommendation results to more effectively learn users' interests, persuade them for certain conversions, collect their explicit feedback (such as rating), as well as actively solicit additional sophisticated user feedback such as their suggestions for future product/service improvement.

The terms “service virtual agent”, “virtual agent”, “conversational agent”, “agent”, “bot” and “chat bot” may be used interchangeably herein.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

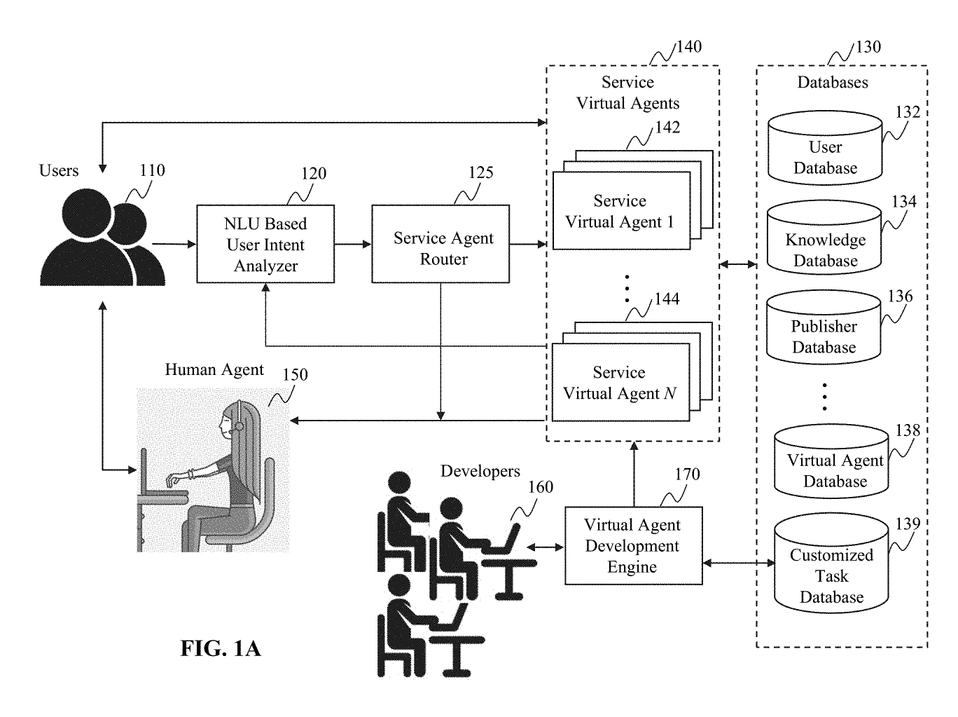

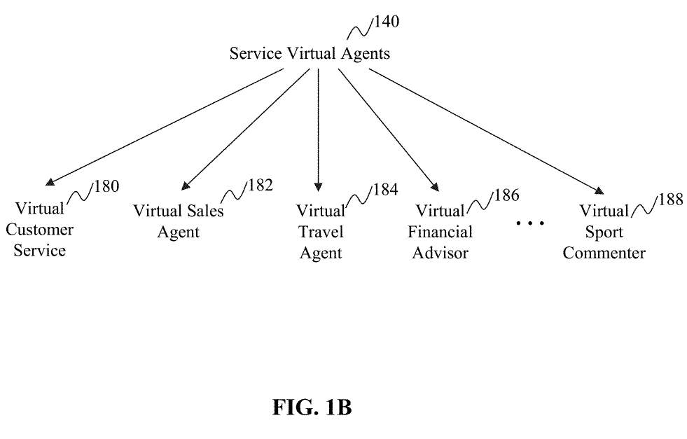

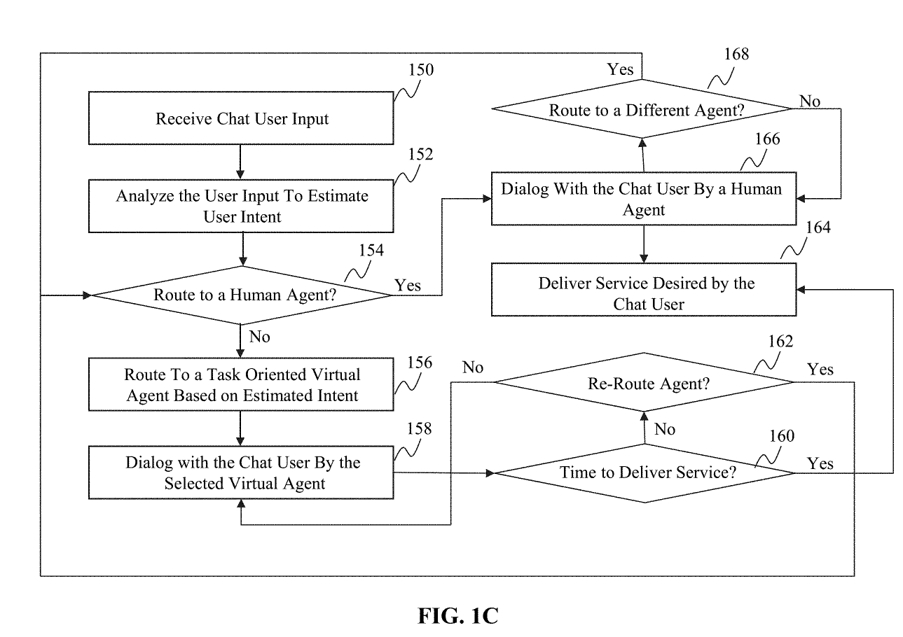

FIG. 1A depicts a framework of the development and applications of service virtual agents, according to an embodiment of the present teaching. In this example, the disclosed system may include an NLU (natural language understanding) based user intent analyzer 120, a service agent router 125, N service virtual agents 140, databases 130, and a virtual agent development engine 170.

The service virtual agents 140 in FIG. 1A may perform direct dialogs with the users 110. Each virtual agent may focus on a specific service or domain when chatting with one or more users. For example, a user may send utterances to the NLU based user intent analyzer 120. Upon receiving an utterance from a user, the NLU based user intent analyzer 120 may analyze the user's intent based on an NLU model and the utterance. In one embodiment, the NLU based user intent analyzer 120 may utilize machine learning technique to train the NLU model based on real and simulated user-agent conversations as well as contextual information of the conversations. The NLU based user intent analyzer 120 may estimate the user intent and send the estimated user intent to the service agent router 125 for agent routing.

The service agent router 125 in this example may receive the estimated user intent from the NLU based user intent analyzer 120 and determine one of the service virtual agents 140 based on the estimated user intent. FIG. 1B illustrates exemplary service virtual agents, according to an embodiment of the present teaching. For example, as shown in FIG. 1B, a service virtual agent may be a virtual customer service 180, a virtual sales agent 182, a virtual travel agent 184, a virtual financial advisor 186, or a virtual sport commenter 188, etc.

Referring back to FIG. 1A, once the service agent router 125 determines that a service virtual agent has a domain or service matching the estimated user intent, the service agent router 125 can route the user's utterance to the corresponding virtual agent to enable a conversation between the virtual agent and the user.

During the conversation between the virtual agent and the user, the virtual agent can analyze dialog states of the dialog and manage real-time tasks related to the dialog, based on data stored in various databases, e.g. a knowledge database 134, a publisher database 136, and a customized task database 139. The virtual agent may also perform product/service recommendation to the user based on a user database 132. In one embodiment, when the virtual agent determines that the user's intent has changed or the user is unsatisfied with the current dialog, the virtual agent may redirect the user to a different agent based on a virtual agent database 138. The different agent may be a different virtual agent or a human agent 150. For example, when the virtual agent detects that the user is asking for a sale related to a large quantity or a large amount of money, e.g. higher than a threshold, the virtual agent can escalate the conversation to the human agent 150, such that the human agent 150 can take over the conversation with the user. The escalation may be seamless and not causing any delay to the user.

The virtual agent development engine 170 in this example may develop a customized virtual agent for a developer via a bot design programming interface provided to the developer. The virtual agent development engine 170 can work with multiple developers 160 at the same time. Each developer may request a customized virtual agent with a specific service or domain. As such, a service virtual agent, e.g. the service virtual agent 1 142, may have different versions as shown in FIG. 1A, each of which corresponds to a customized version generated based on a developer's specific request or specific parameter values. The virtual agent development engine 170 may also store the customized tasks into the customized task database 139, which can provide previously generated tasks as a template for future task generation or customization during virtual agent development.

FIG. 1C is a flowchart of an exemplary process for service agent development and application, according to an embodiment of the present teaching. When an input is received from a chat user at 150, the input from the chat user is analyzed, at 152, to estimate the intent of the chat user. It is then determined, at 154 based on the estimated intent, whether the chat user should be directed to a human or virtual agent. If the chat user is directed to a human agent, the process proceeds to 166 where the dialog with the chat user is conducted with a human agent. The dialog with the human agent may continue until a service is delivered, at 164, to the chat user. The human agent may also assess from time to time during the dialog, at 168, whether there is a need to route the chat user to a different agent, either virtual or human. If no, the conversation continues at 166. If there is a need to route the chat user to other agent, the process proceeds to 154, where it is determined whether to route to a (different) human agent or a virtual agent. Once the new conversation is initiated with a different agent, the process proceeds to 150.

If a decision is made, at 154, to use a virtual agent to carry out a dialog with a chat user, a task oriented virtual agent is selected, at 156, based on, e.g., the estimated intent of the chat user. For example, if it is estimated that a chat user's intent is to look for flight information, the chat user may be routed to a travel virtual agent designed to specifically handle tasks related to flight reservations. If a chat user's intent is estimated to be related to car rental, the chat user may accordingly be routed to a rental car virtual agent. The selected virtual agent and the chat user proceed with the dialog at 158. Similarly, during the dialog, the virtual agent attempts to ascertain what the chat user is seeking and the ultimate goal is to deliver what the chat user desires.

During the dialog between a virtual agent and a chat user, it may be routinely assessed, at 160, whether it is time to deliver information/service to the chat user. If it is determined, at 160, that it is time to deliver the desired service to the chat user, the service/information is delivered to the chat user at 164. If it is determined at 162 that the virtual agent still cannot determine what the chat user desires, it is assessed, at 162, whether the chat user needs to be routed to a different agent, either human or virtual. The assessment may be based on different criteria. Examples include that the chat user somewhat seems unhappy or upset, that the dialog has been long without a clear picture what the chat user wants, or that what the chat user is interested in is not what the virtual agent can handle. If it is determined not to re-route, the process proceeds back to 158 to continue the dialog. Otherwise, the process proceeds to 154 to decide whether the chat user is to be re-routed to a human agent or a (different) virtual agent.

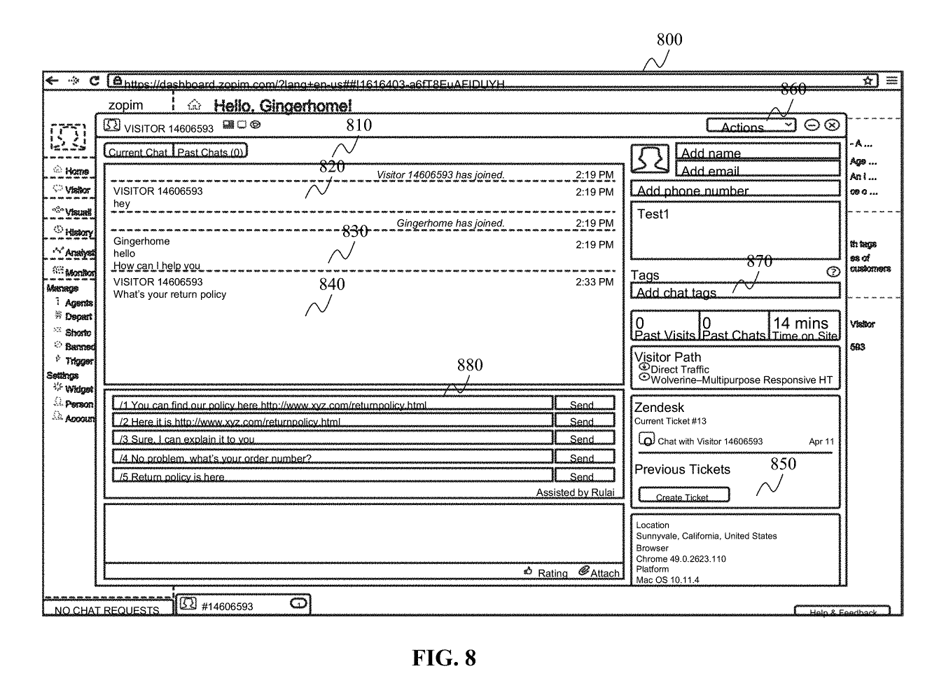

Another aspect of the present teaching relates to the virtual agent development engine 170, which enables bot design and programming via graphical objects by integrating modules via drag and drop of selected graphical objects with flexible means to customize. Details on this aspect of the present teaching are provided with reference to FIGS. 8-13C.

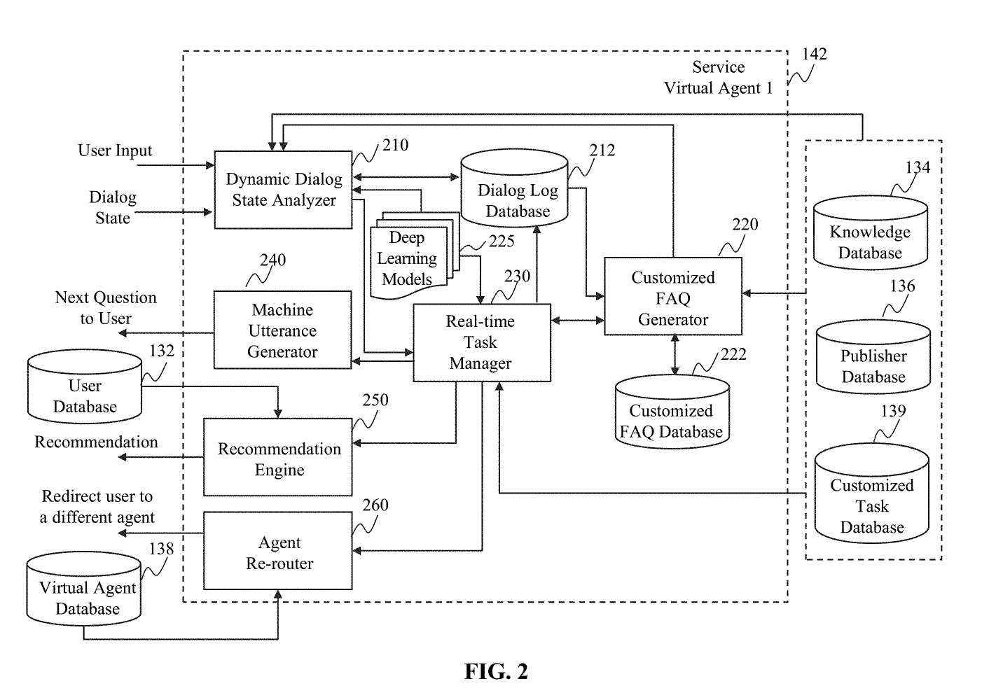

FIG. 2 depicts an exemplary high level system diagram of a service virtual agent 1 142, according to an embodiment of the present teaching. The service virtual agent 1 142 in this example comprises a dynamic dialog state analyzer 210, a dialog log database 212, one or more deep learning models 225, a customized FAQ generator 220, a customized FAQ database 222, various databased (e.g., a knowledge database 134, a publisher database 136, . . . , and a customized task database 139), a real-time task manager 230, a machine utterance generator 240, a recommendation engine 250, and an agent re-router 260.

In operation, the dynamic dialog state analyzer 210 continuously receives and analyzes the input from the user 110 and determines dialog state of the dialog with the user 110. The analysis of the user's input may be achieved via natural language processing (NLP), which can be a key component of the dynamic dialog state analyzer 210. Different NLP techniques can be utilized e.g. based on a deep learning model 225. The dynamic dialog state analyzer 210 record dialog logs including both the dialog states and other metadata related to the dialog, into the dialog log database 212, which can be used for generating customized FAQs. The dynamic dialog state analyzer 210 may also estimate user intent based on the analysis of the dialog state and user input, and send the estimated user intent to the real-time task manager 230 for real-time task management.

In one embodiment, the dynamic dialog state analyzer 210 may analyze the user input based on customized FAQ data obtained from the customized FAQ generator 220. The customized FAQ generator 220 in this example may generate FAQ data customized for the domain associated with the service virtual agent 1 142, and/or customized based on a developer's specific request. For example, when the service virtual agent 1 142 is a virtual sales agent, the customized FAQ generator 220 may generate the following FAQs and their corresponding answers: What products are you selling? What is the price list for the products being sold? How can I pay for a product? How much is the shipping fee? How long will be the shipping time? Is there any local store? The customized FAQ generator 220 may generate these customized FAQs based on the knowledge database 134, the publisher database 136, and the customized task database 139. The knowledge database 134 may provide information about general knowledge related to products and services. The publisher database 136 may provide information about publishers selling the products/services for a company, publishers publishing advertisements for some products/services, or publishers that are utilizing the service virtual agent 1 142 to provide customer services. The customized task database 139 may store data related to customized tasks generated according to some developers' specific requests. For example, if the service virtual agent 1 142 is a customized version of a virtual sales agent developed based on a specific request for selling cars to buyers in a location having a severe climate including many snow storms, the customized FAQ generator 220 may generate more customized FAQs, e.g.: Do you like to add snow tires on your car? What cars have all-wheel-drive functions? The customized FAQ generator 220 may store the generated FAQs and their corresponding answers into the customized FAQ database 222, and may retrieve some of them to generate more customized FAQs.

The customized FAQ generator 220 may also generate customized FAQs based on data obtained from the dialog log database 212. For example, based on logs of previous dialogs between the service virtual agent 1 142 and various users, the customized FAQ generator 220 may identify which question is asked very frequently and which question is asked infrequently. Based the frequencies of the questions asked in the logs, the customized FAQ generator 220 may generate or update FAQs stored in the customized FAQ database 222. The customized FAQ generator 220 may also send the customized FAQ data to the real-time task manager 230 for determining next task type.

According to one embodiment of the present teaching, the disclosed system may also include an offline conversation data analysis component, which can mine important statistical information and features from historical conversation logs, human action logs and system logs. The offline conversation data analysis component, not shown, may be either within or outside the service virtual agent 1 142. The important statistical information and signals (e.g. the frequency of each types of question and answer, and the frequency of human-edits for each question, etc.) can be used by other system components (such as the customized FAQ generator 220 for identifying important new FAQs, and the recommendation engine 250 for performing high-quality recommendations for products and services,) for their addressed specific tasks for the disclosed system.

The real-time task manager 230 in this example may receive estimated user intent and dialog state data from the dynamic dialog state analyzer 210, customized FAQ data from the customized FAQ generator 220, and information from the customized task database 139 . Based on the dialog state and the FAQ data, the real-time task manager 230 may determine a next task for the service virtual agent 1 142 to perform. Such decisions may be made based also on information or knowledge from the customized task database 139. For example, if an underlying task is assist a chat user to find the weather of a locale, the knowledge from the customized task database 139 for this particular tasks may indicate that for this particular task, a virtual agent or bot needs to collection information about the locale (city), date, or even time in order to proceed to get appropriate weather information. Similarly, if the underlying task is for assisting a chat user to get a rental car, the knowledge or information stored in the customized task database 139 may provide guidance as to what information a virtual agent or bot needs to collect from the chat user in order to assist effectively. In the rental car example, the information that needs to be collected may involve pick-up location, drop-off location, date, time, name of the chat user, driver license, type of car desired, price range, etc. Such information may be fed to the real-time task manager 230 so that it can determined what questions to ask a chat user.

According to some embodiment of the present teaching, there may be more types of actions or tasks. For example, an action may be to continue to solicit additional input from the user (in order to narrow down the specific interest of the user) by asking appropriate questions. Alternatively, an action may also be to proceed to identify appropriate product to be recommended to the user, e.g., when it is decided that the user input at that point is adequate to ascertain the intent. Thus, the real-time task manager 230 may be operating in a space that includes a machine action sub-space and a user action sub-space, both of which may be established via machine learning. In addition, the next action may also be to re-route the user to a different agent. The real-time task manager 230 can determine which action to take based on a deep learning model 225 and data obtained from the knowledge database 134, the publisher database 136, and the customized task database 139.

When the real-time task manager 230 decides to continue the conversation with the user to gather additional information, the real-time task manager 230 also determines the appropriate question to ask the user. Then the real-time task manager 230 may send the question to the machine utterance generator 240 for generating machine utterances corresponding to the question. The machine utterance generator 240 may generate machine utterances corresponding to the question to be presented to the user and then present the machine utterances to the user. The generation of the machine utterances may be based on textual information or oral using, e.g., text to speech technology.

When the real-time task manager 230 determines that there has been adequate amount of information gathered to identify an appropriate product or service for the user, the real-time task manager 230 may then proceed to invoke the recommendation engine 250 for searching an appropriate product or service to be recommended.

The recommendation engine 250, when invoked, searches for product appropriate for the user based on the conversation with the user. In searching for a recommended product, in addition to the user intent built during the conversation, the recommendation engine 250 may also further individualize the recommendation by accessing the user's profile from the user database 132. In this manner, the recommendation engine 250 may individualize the recommendation based on both user's known interest (from the user database 132) and the user's dynamic interest (from the conversation). The search may yield a plurality of products and such searched product may be ranked based on a machine learning model.

When the real-time task manager 230 determines that the conversation with the user is involved with a price that is higher than a threshold, or that the user has a new intent associated with a different domain than that of the service virtual agent 1 142, or that the user is in a dissatisfaction mood, the real-time task manager 230 may then invoke the agent re-router 260 for re-routing the user to a different agent. The agent re-router 260, when invoked, can re-route the user to a second service virtual agent, when the user is detected to have a new intent associated with that second service virtual agent. In another case, the agent re-router 260 may re-route the user to the human agent 150, when the conversation with the user is involved with a price that is higher than a threshold or when the user is detected to be in a dissatisfaction mood with the service virtual agent 1 142. In yet another case, the agent re-router 260 may re-direct the user's conversation to the NLU based user intent analyzer 120 to perform the NLU based user intent analysis again and to re-route the user to a corresponding virtual agent, when e.g. the service virtual agent 1 142 detects that the user has a new intent associated with a different domain than that of the service virtual agent 1 142 but cannot determine which virtual agent corresponds to the same domain as the new intent.

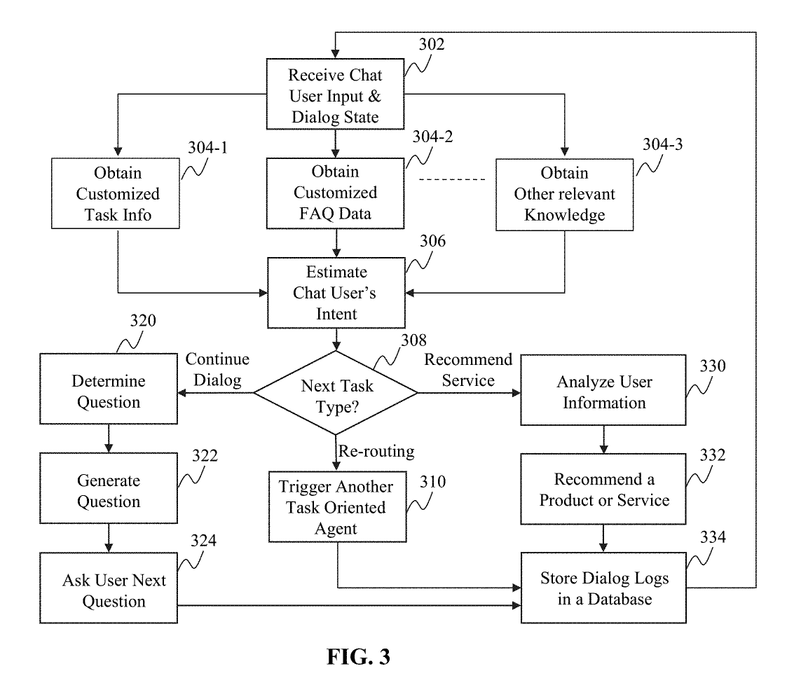

FIG. 3 is a flowchart of an exemplary process of a service virtual agent, e.g. the service virtual agent 1 142 in FIG. 2, according to an embodiment of the present teaching. At 302, a user input and/or dialog state are received. The input can be either the initial input from the user or an answer from the user provided in response to a question posted by the service virtual agent 1 142. Various relevant information may then be obtained at 304, which includes customized task information related to customers at 304-1, customized FAQ data at 304-2, . . . , and other types of relevant knowledge/information at 304-3. The received different types of information are then analyzed to estimate chat user's intent at 306. For example, customized FAQ data and customized task information may be utilized to detect the intent of the chat user. The intent may be gradually estimated based on the dialog state which is continuously built up based on received input from the chat user. At 308, the real-time task manager 230 determines what the next task type is based on the current estimated dialog state.

If the next task type is determined at 308 to continue the question to carry on the conversation, the process goes to 320 to determine the next question to ask the user. At 322, the question is generated in an appropriate form with some utterances. Then the question is asked at 324 to the user. Then the process goes to 334 for storing dialog logs in a database.

If the next task type is determined at 308 to recommend a product or service to the user, the recommendation engine 250 is invoked to analyze, at 330, the user information from the user database 132 and recommends, at 332, one or more products or services that match the dynamically estimated user intent (interest) and/or the user information. Then the process goes to 334 for storing dialog logs in a database.

If the next task type is determined at 308 to re-route the chat user, the process goes to 310 to re-route the user to a different agent. The different agent may be a different virtual agent having a domain that is same or similar to the user's newly estimated intent. The different agent may also be a human agent when the user is detected to be involved in a high-price transaction or be unsatisfied with the current virtual agent. Then the process goes to 334 for storing dialog logs in a database.

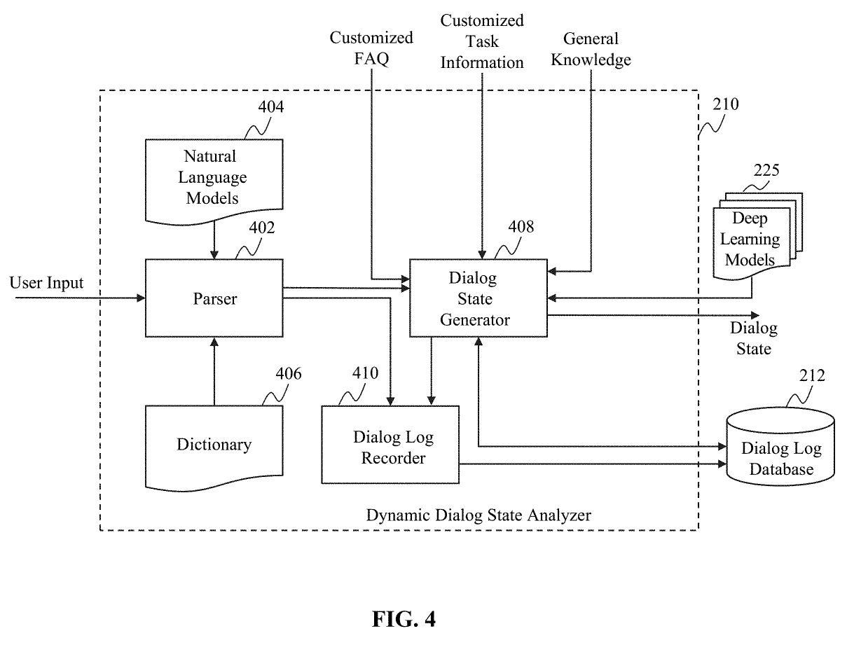

FIG. 4 depicts an exemplary high level system diagram of a dynamic dialog state analyzer 210 in a service virtual agent, e.g. the service virtual agent 1 142 in FIG. 2, according to an embodiment of the present teaching. The dynamic dialog state analyzer 210 can keep track of the dialog state of the conversation with the user and the user's intent based on continuously received user input. The dialog state and user intent are also continuously updated based on the new input from the user. As shown in FIG. 4, the dynamic dialog state analyzer 210 comprises a parser 402, one or more natural language models 404, a dictionary 406, a dialog state generator 408, and a dialog log recorder 410.

The parser 402 in this example may identify information from the user input that provides an answer to the question asked. For example, if the question is “Which brand do you prefer?” and the answer is “I love Apple,” then the parser is to extract “Apple” as the answer to “brand.”

The parser may incorporate NLU techniques, e.g., by employing a deep learning model to analyze a user utterance and extract values of the targeted product. The deep learning model may be trained based on weakly supervised learning mechanism. In the above example, the product may be “smartphone.” The parser 402 may process the user input based on the natural language models 404 and the dictionary 406, as shown in FIG. 4. Relevant information extracted from the user input by the parser 402 may be sent to the dialog state generator 408. The parser 402 may also send the extracted information to the dialog log recorder 410 for recording dialog logs.

Upon receiving the relevant information extracted from the user input, the dialog state generator 408 may generate or update a dialog state of the conversation based on the extracted relevant information. According to one embodiment of the present teaching, the dialog state generator 408 may obtain the customized FAQs from the customized FAQ generator 220, obtain customized task information from the customized task database 139, and obtain general knowledge from the knowledge database 134. Based on the obtained information, the dialog state generator 408 may generate or update a dialog state according to one of the deep learning models 225. For example, upon receiving all related answers of the user extracted from the user input regarding a selling product, the dialog state generator 408 may retrieve a dialog state from the dialog log database 212 and update the dialog state to indicate that the user is ready to buy the product, and it is time to provide payment method or platform to the user. In one embodiment, the dialog state generator 408 may retrieve historic dialog state of the user and concatenate historic dialog state with the current dialog state for the user. The dialog state generator 408 may send the generated or updated dialog state to the dialog log recorder 410 for recording dialog logs.

The dialog log recorder 410 in this example may receive both extracted information from the parser 402 and the dialog state information from the dialog state generator 408 related to the conversation. The dialog log recorder 410 may then record or update the dialog log for the conversation, and store it in the dialog log database 212.

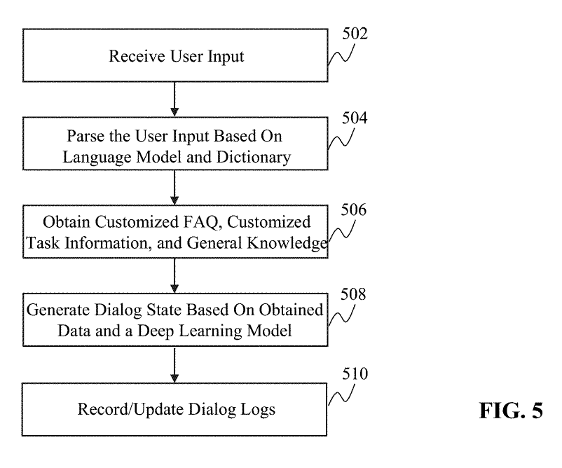

FIG. 5 is a flowchart of an exemplary process for a dynamic dialog state analyzer in a service virtual agent, e.g. the dynamic dialog state analyzer 210 in FIG. 4, according to an embodiment of the present teaching. A user input is received first at 502, and is parsed, at 504, based on language models/dictionary. Customized FAQ, customized task information, and general knowledge are obtained at 506. Based on obtained data and a deep learning model, a dialog state is generated or updated at 508. At 510, the dialog logs including e.g. the dialog state and the extracted information from the user input, and other metadata related to the conversation, are recorded or updated.

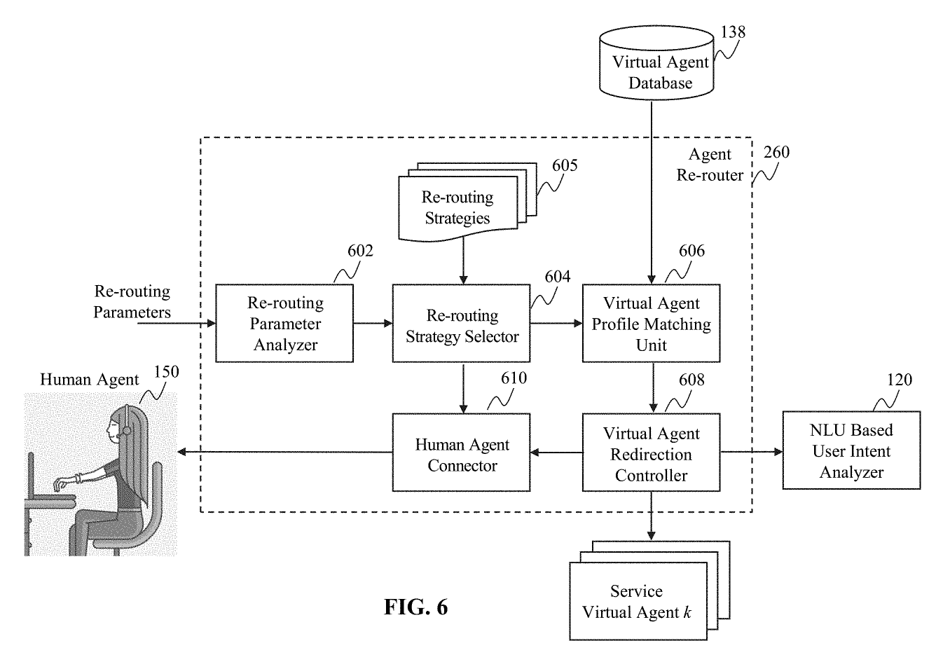

FIG. 6 depicts an exemplary high level system diagram of an agent re-router 260 in a service virtual agent, e.g. the service virtual agent 1 142 in FIG. 2, according to an embodiment of the present teaching. In this exemplary embodiment, the agent re-router 260 comprises a re-routing parameter analyzer 602, a re-routing strategy selector 604, a virtual agent profile matching unit 606, a virtual agent redirection controller 608, a human agent connector 610, and one or more re-routing strategies 605. The re-routing parameter analyzer 602 can receive re-routing parameters from the real-time task manager 230 and analyze them to determine the reason for re-routing. For example, the re-routing parameters may indicate that the user has a satisfaction score lower than a threshold, the user wants to start a transaction involving a price higher than a threshold, the user's newly estimated intent is not associated with the domain of the current virtual agent, or the user has expressed an intent to speak with a human agent, e.g. a human representative. The re-routing parameter analyzer 602 may send the re-routing parameters to the re-routing strategy selector 604 for selecting a re-routing strategy.

Based on the re-routing parameters, the re-routing strategy selector 604 may select one of the re-routing strategies 605 for re-routing the user. A re-routing strategy may indicate how to re-routing the user and the user should be re-routed based on what condition and what threshold. For example, a selected re-routing strategy by the re-routing strategy selector 604 may indicate that when the user's newly estimated intent is not associated with the domain of the current virtual agent, the agent re-router 260 is to find another virtual agent that has a domain matching the user's newly estimated intent. In another example, a selected re-routing strategy by the re-routing strategy selector 604 may indicate that when the user has a satisfaction score lower than a threshold, when the user wants to start a transaction involving a price higher than a threshold, or when the user has expressed intent to speak with a human agent, the agent re-router 260 is to escalate the user to a human agent regardless of the newly estimated user intent.

According to the selected re-routing strategy, the re-routing strategy selector 604 may either invoke the virtual agent profile matching unit 606 to find a virtual agent having a profile matching the user's newly estimated intent, or invoke the human agent connector 610 to connect the user to the human agent 150. It can be understood that, in accordance with one embodiment of the present teaching, a selected re-routing strategy may indicate that the re-routing strategy selector 604 should invoke the virtual agent profile matching unit 606 first, and only when the virtual agent profile matching unit 606 cannot find a virtual agent having a profile matching the user's newly estimated intent, the re-routing strategy selector 604 will invoke the human agent connector 610 to connect the user to the human agent 150.

The virtual agent profile matching unit 606 in this example may obtain profiles of different virtual agents from the virtual agent database 138. It can be understood that the virtual agent database 138 may store information more than the profiles of the virtual agents. For example, the virtual agent database 138 may also store contextual information and metadata related to each virtual agent. A profile of a virtual agent may indicate what domain or service the virtual agent is associated with. Based on the obtained profiles, the virtual agent profile matching unit 606 may determine a matching score between each virtual agent's profile and the user's newly estimated intent. Then the virtual agent profile matching unit 606 may determine a virtual agent having the highest matching score and send the information of the virtual agent and the highest matching score to the virtual agent redirection controller 608 for redirection control.

The virtual agent redirection controller 608 in this example may receive the information of the virtual agent having the highest matching score from the virtual agent profile matching unit 606, and control the redirection of the user based on the selected re-routing strategy. In one example, according to a selected re-routing strategy, the virtual agent redirection controller 608 may directly re-route the user to the virtual agent having the highest matching score, e.g. service virtual agent k, regardless how high or how low the highest matching score is. In another example, according to a selected re-routing strategy, the virtual agent redirection controller 608 may compare the highest matching score with a threshold, and re-route the user to the virtual agent having the highest matching score when the highest matching score is larger than the threshold. When the highest matching score is not larger than the threshold, the virtual agent redirection controller 608 may either instruct the human agent connector 610 to connect the user to the human agent 150, or send the redirection information including the user's newly estimated intent to the NLU based user intent analyzer 120 for further analyzing the user intent based on NLU for redirection.

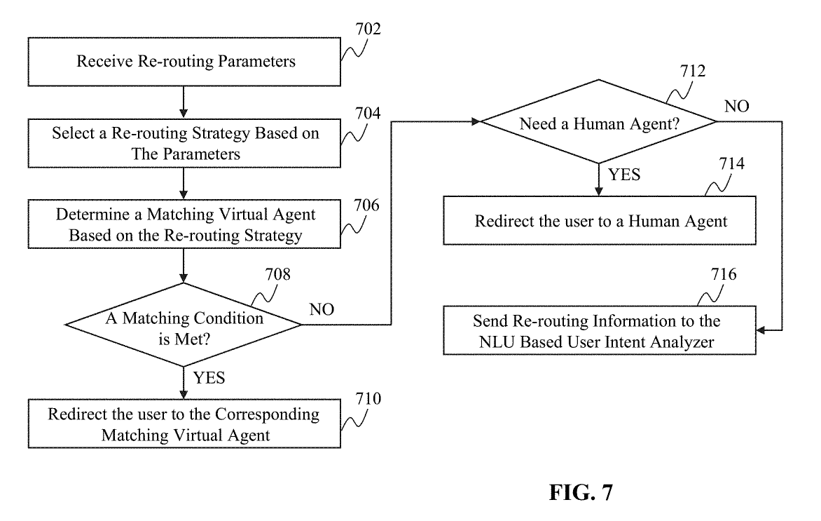

FIG. 7 is a flowchart of an exemplary process of an agent re-router in a service virtual agent, e.g. the agent re-router 260 in FIG. 6, according to an embodiment of the present teaching. Re-routing parameters are received and analyzed at 702. Based on the re-routing parameters, a re-routing strategy is selected at 704. A matching virtual agent is determined at 706 based on the re-routing strategy. The matching virtual agent may have a highest matching score between its profile and the user's newly estimated intent.

At 708, it is determined whether a matching condition is met. For example, it may be determined at 708 whether the highest matching score is higher than a predetermined threshold. If so, the process goes to 710, where the user is redirected to the corresponding matching virtual agent. Otherwise, the process goes to 712, where it is determined whether a human agent is needed. This can be determined based on whether the user has expressed intent to speak to a human agent and/or whether the user is involved in a serious transaction, e.g. a transaction related to a price higher than a threshold.

If it is determined at 712 that a human agent is needed, the process goes to 714, where the user is redirected to the human agent. Otherwise, if it is determined at 712 that a human agent is not needed, the process goes to 716 where the re-routing information is sent to the NLU based user intent analyzer 120 for further analysis of user intent. When the final virtual agent is selected, the selected virtual agent may then generate automatically an utterance or a response to the user.

FIG. 8 illustrates an exemplary user interface 800 during a dialog between a service agent and a chat user, according to an embodiment of the present teaching. As shown in FIG. 8, the service agent called “Gingerhome” is chatting with a chat user called “VISITOR 14606593.” Shown in FIG. 8 is an exemplary bot-assisted agent-side conversation user interface. That is, it is an interface used by a human agent who is assisted by a virtual agent. The interface include different dialog boxes in which each side (chat user and the bot-assisted agent) can each enter their sentences (820, 830, and 840). This agent-side interface also includes various types of information and different actionable sub-interfaces. For example, it includes some historical information related to the current ongoing conversation, shown to list “previous tickets/talks” (850). It also provides agent-selectable actions (860) which may be presented, once clicked, as a drop-down list, editable tags (870). The bot-assisted agent may also add topic tags about the current chat. The agent is assisted by a bot. For example, when the chat user asked “What is your return policy?” (in 840), the bot that is assisting the human agent provides a list of possible responses corresponding to a list of possible utterances tagged as “Assisted by Rulai.” Each of the list of utterances suggested by the bot may be adopted by the human agent when the associated “Send” icon is clicked. In this example, a list of alternative choices of utterances is provided in response to the chat user's question “what is your return policy” in 840.

The conversation between a chat user and a bot-assisted human agent may continue as in a FAQ dialog or additional task oriented virtual agent may be triggered to take over the conversation with the chat user. For example, the conversation in boxes 820, 830, and 840 may correspond to an FAQ. In certain situations, in order to carry on a conversation, some task oriented agent, whether a human or a virtual agent, may be triggered. For example, when the chat user asks “What is your return policy,” the bot assisting the human agent provides several possible responses as provided in 880. The bot-assisted human agent may then select one response by clicking on a corresponding “Send” icon, e.g., selecting response “Sure. I can explain to you.” Such a selected response may trigger a virtual agent, e.g., in this case, a virtual agent that specializes in “explaining return policy.” Once selected, the selected task oriented virtual agent (for explaining return policy) may then step in to continue the conversion with the chat user.

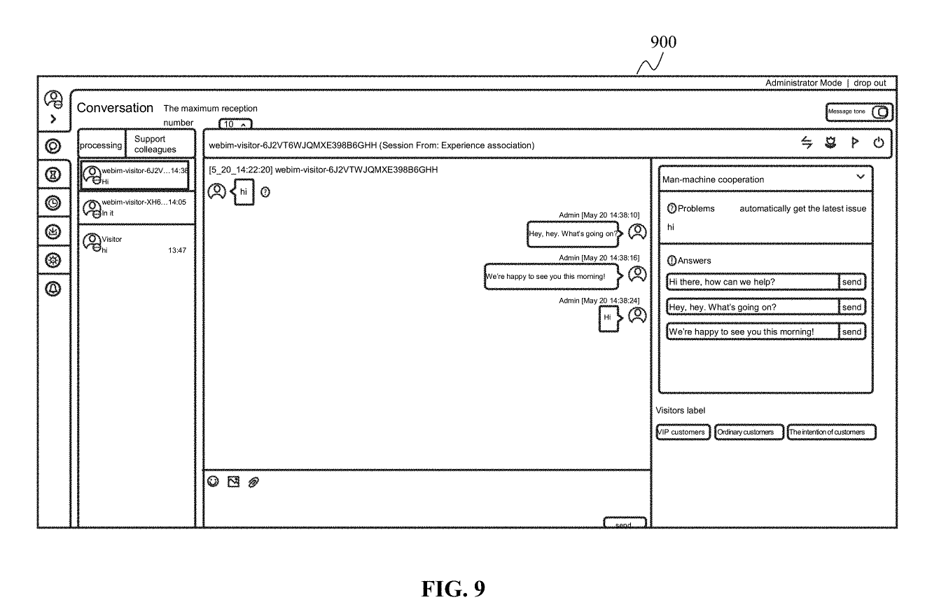

FIG. 9 illustrates an exemplary user interface 900 during dialogs between a service virtual agent and multiple chat users, according to an embodiment of the present teaching. As shown in FIG. 9, the service virtual agent called “Admin” can chat with multiple chat users in a same time period. FIG. 9 shows a specific time instance while the virtual agent is currently chatting with a chat user called “webim-visitor-6J2VTWJQMXE398B6GHH.” In this interface, different bot suggested responses may be presented to the agent. The bot-assisted agent can activate “Send” of a desired response and send the corresponding response utterance to the chat user. Such suggested responses may be used by the agents to carry on a conversation. When assisted by bot suggested responses, the agents according to the present teaching can handle multiple customer requests simultaneously via this interface at ease.

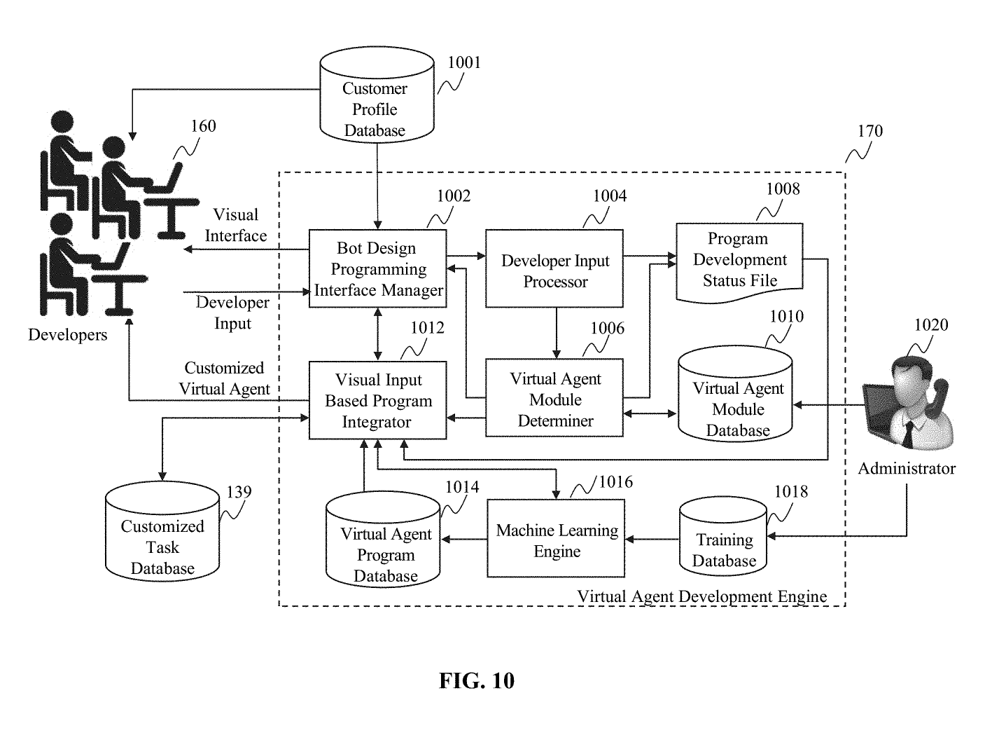

FIG. 10 depicts an exemplary high level system diagram of a virtual agent development engine 170, according to an embodiment of the present teaching. As shown in FIG. 10, the virtual agent development engine 170 in this example includes a bot design programming interface manager 1002, a developer input processor 1004, a virtual agent module determiner 1006, a program development status file 1008, a virtual agent module database 1010, a visual input based program integrator 1012, a virtual agent program database 1014, a machine learning engine 1016, and a training database 1018.

The bot design programming interface manager 1002 in this example may provide a bot design programming interface to a developer 160 and receive inputs from the developer via the bot design programming interface. In one embodiment, the bot design programming interface manager 1002 may present, via the bot design programming interface, a plurality of bot design graphical programming objects to the developer. Each of the plurality of graphical programming objects may represent a module corresponding to an action to be performed by the virtual agent. The bot design programming interface manager 1002 may generate a bot-design programming interface based on different types of information. For example, each customized bot may be task oriented. Depending the tasks, the bot design programming interface may be different. In FIG. 10, it is shown that information stored in a customer profile database 1001 is provided to the bot design programming interface manager 1002. A customer may be engaged in different types of business, which may dictate what types of tasks that a virtual agent developed for the customer need to be able to handle. In FIG. 10, information from the customer profile database 1001 is provided to the bot-design programming interface manager 1002 and is utilized to make a decision what type of virtual agent is to developed (virtual travel agent, virtual rental agent, etc.).

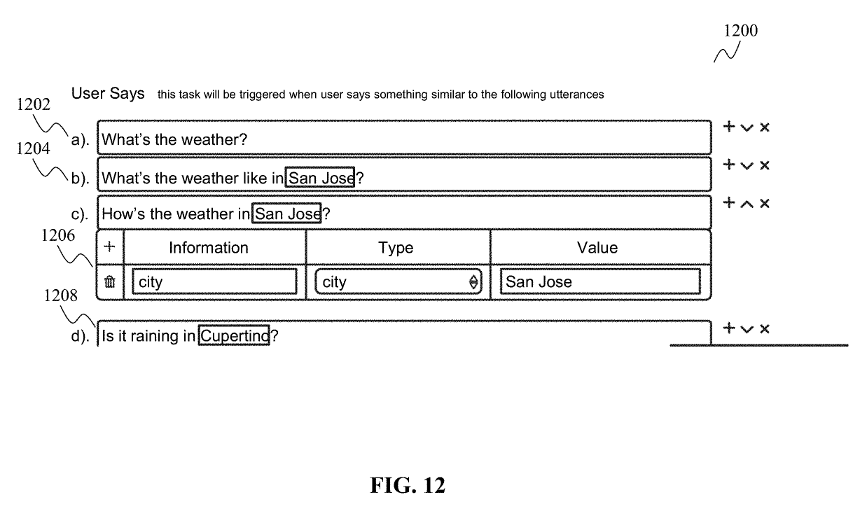

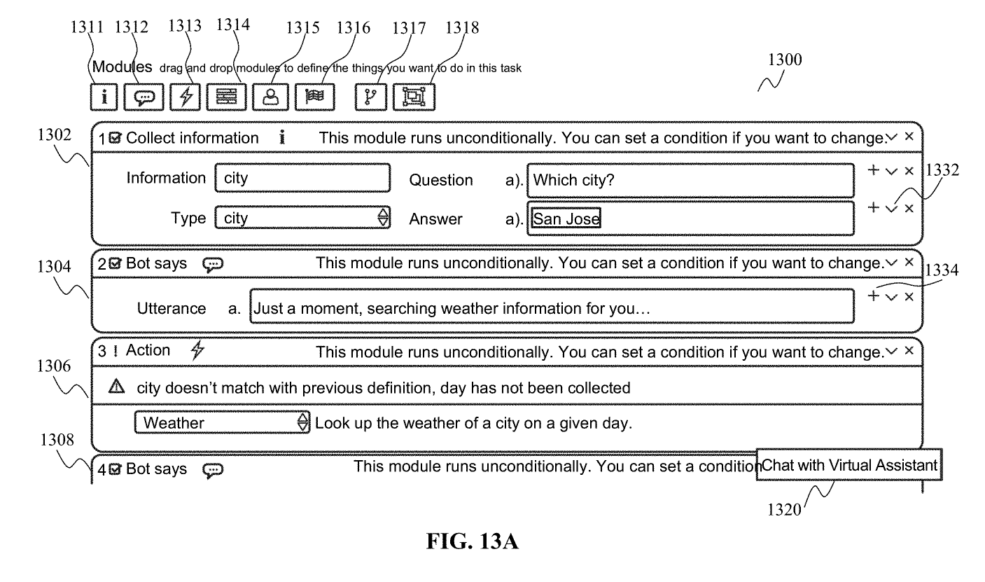

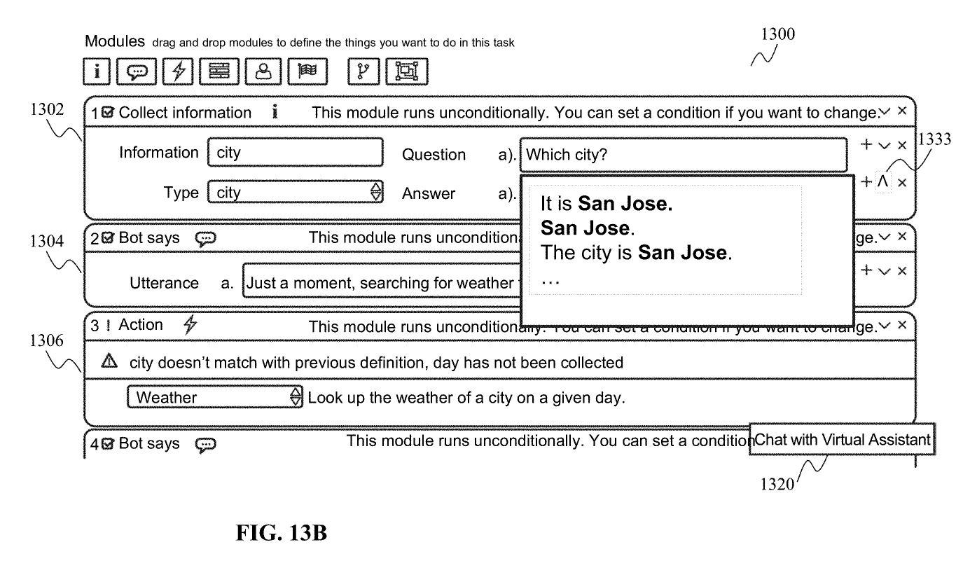

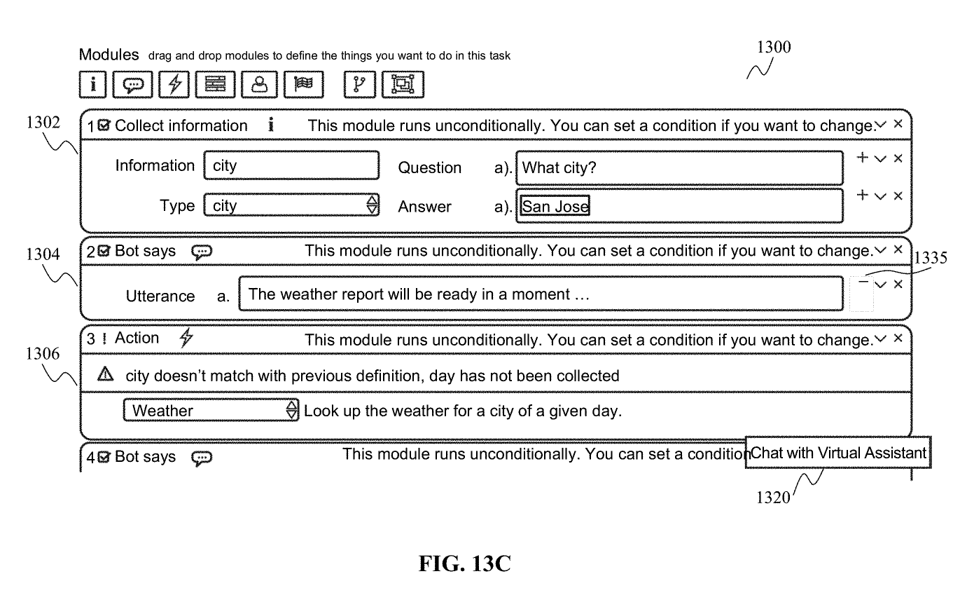

In addition, the past dialogs may also provide useful information for the development of a virtual agent and thus may be input to the bot design programming interface manager 1002 (not shown in FIG. 10). For instance, from archived dialogs, (e.g., gathered from the dialog log databases 212 of different virtual agents), different utterances corresponding to the same task may be identified and offered by the bot design programming interface manager 1002 as alternative ways to trigger the virtual agent in development. This is discussed in more detail in reference to FIGS. 12 and 13B.

The bot design programming interface manager 1002 may forward the developer input to the developer input processor 1004 for processing. The bot design programming interface manager 1002 may also forward the developer input to the visual input based program integrator 1012 for integrating different modules to generate a customized virtual agent with details shown below. It can be understood that the bot design programming interface manager 1002 may cooperate with multiple developers 160 at the same time to developer multiple customized virtual agents.

The developer input processor 1004 may process the developer input to determine the developer's intent and instruction. For example, an input received from the developer may indicate the developer's selection of a graphical object of the plurality of graphical objects, which means that the developer selects a module corresponding to the graphical object. In another example, the input received from the developer may also provide information about the order of the selected module to be included in the virtual agent. The developer input processor 1004 may send each processed input to the virtual agent module determiner 1006 for determining modules of the virtual agent. The developer input processor 1004 may also store each processed input to the program development status file 1008 to record or update the status of the program development for the virtual agent.

Based on the processed input, the virtual agent module determiner 1006 may determine a module for each of the graphical objects selected by the developer. For example, the virtual agent module determiner 1006 may identify the graphical objects selected by the developer. Then for each graphical object selected by the developer, the virtual agent module determiner 1006 may retrieve a virtual agent module corresponding to the graphical object from the virtual agent module database 1010. The virtual agent module determiner 1006 may send the retrieved virtual agent modules corresponding to all of the developer's selection for the virtual agent, to the bot design programming interface manager 1002 for presenting the virtual agent modules to the developer via the bot design programming interface. The virtual agent module determiner 1006 may also store each retrieved virtual agent module the program development status file 1008 to record or update the status of the program development for the virtual agent.

According to one embodiment of the present teaching, the virtual agent module determiner 1006 may determine some of the modules selected by the developer for further customization. For each of the determined modules, the virtual agent module determiner 1006 may determine at least one parameter of the module based on inputs from the developer. For example, for a module corresponding to an action of sending an utterance to the chat user, the virtual agent module determiner 1006 may send the module to the bot design programming interface manager 1002 to present the module to the developer. The developer may then enter a sentence for the module, such that when the module is activated, the virtual agent will send the sentence entered by the developer as an utterance to the chat user. In another example, the parameter for the module may be a condition upon which the action corresponding to the module is performed by the virtual agent, such that the developer may define a customized condition for the action to be performed. In this manner, the virtual agent module determiner 1006 can generate more customized modules, and store them into the virtual agent module database 1010 for future use. The virtual agent module determiner 1006 may send the generated and retrieved modules to the visual input based program integrator 1012 for program integration.

After the developer finishes selecting modules and customizing modules, the developer may input an instruction to integrate the modules to generate the customized virtual agent. For example, the bot design programming interface manager 1002 may present a button on the bot design programming interface to the developer, such that when the developer clicks on the button, the bot design programming interface manager 1002 can receive an instruction from the developer to integrate the modules, and enable the developer to chat with the customized virtual agent after the integrating for testing. Once the bot design programming interface manager 1002 receives the instruction for integrating, the bot design programming interface manager 1002 may inform the visual input based program integrator 1012 to perform the integration.

Upon receiving the instruction for integrating, the visual input based program integrator 1012 in this example may integrate the modules obtained from the virtual agent module determiner 1006. For each of the modules, the visual input based program integrator 1012 may retrieve program source code for the module from the virtual agent program database 1014. For modules that have parameters customized based on inputs of the developer, the visual input based program integrator 1012 may modify the obtained source codes for the module based on the customized parameters. In one embodiment, the visual input based program integrator 1012 may invoke the machine learning engine 1016 to further modify the codes based on machine learning.

The machine learning engine 1016 in this example may extend the source code to include more parameter values similar to exemplary parameter values entered by the developer. For example, for a weather agent having a module collecting information about the city in which weather is queried, the developer may enter several city names as examples. The machine learning engine 1016 may obtain training data from the training database 1018 and modify the codes to adapt to all city names as in the examples. In one embodiment, an administrator 1020 of the virtual agent development engine 170 can input some initial data in the training database 1018 and the virtual agent module database 1010, e.g. based on previous real user-agent conversations and commonly used virtual agent modules, respectively. The machine learning engine 1016 may send the machine learned codes to the visual input based program integrator 1012 for integration.

Upon receiving the modified codes from the machine learning engine 1016, the visual input based program integrator 1012 may integrate the modified codes to generate the customized virtual agent. In one embodiment, the visual input based program integrator 1012 may also obtain information from the program development status file 1008 to refine the codes based on the development status recorded for the virtual agent. After generating the customized virtual agent, the visual input based program integrator 1012 may send the customized virtual agent to the developer. In addition, the visual input based program integrator 1012 may store the customized virtual agent and/or customized task information related to the virtual agent into the customized task database 139.

According to one embodiment of the present teaching, the visual input based program integrator 1012 may store the customized virtual agent as a template, and retrieve the template from the customized task database 139 when a developer is developing a different but similar virtual agent. In this case, the bot design programming interface manager 1002 may present the template to the developer via another bot design programming interface, such that the developer can directly modify the template, e.g. by modifying some parameters, instead of selecting and building all modules of the virtual agent from beginning.

According to one embodiment of the present teaching, the bot design programming interface manager 1002 may provide another bot design programming interface to the developer, such that the developer input processor 1004 can receive and process one or more utterances input by the developer. Each of the input utterances, when entered by a chat user, can trigger a dialog between the virtual agent and the chat user.

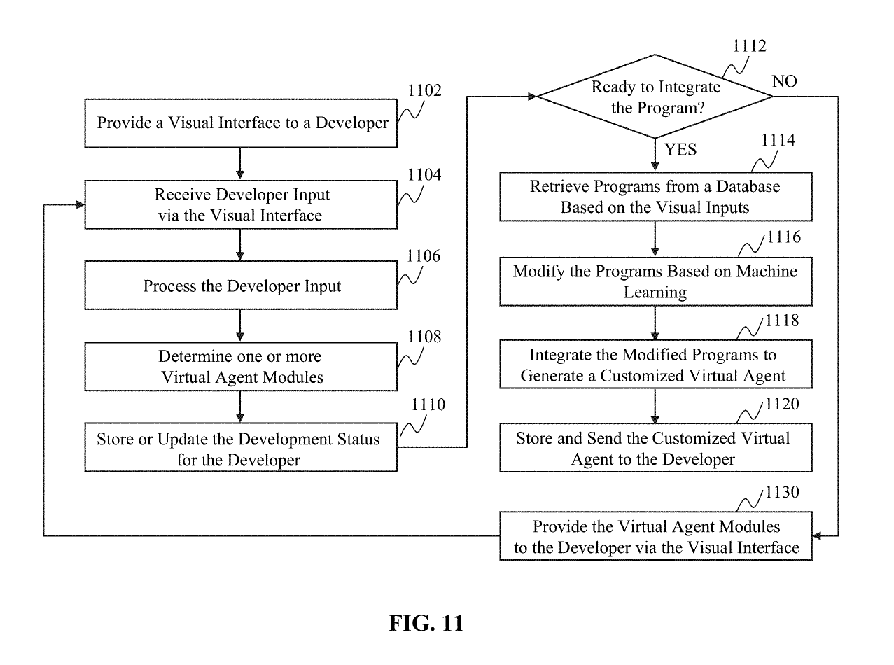

FIG. 11 is a flowchart of an exemplary process of a virtual agent development engine, e.g. the virtual agent development engine 170 in FIG. 10, according to an embodiment of the present teaching. A bot design programming interface is provided at 1102 to a developer. One or more inputs are received at 1104 from the developer via the bot design programming interface. The inputs are processed at 1106. One or more virtual agent modules are determined at 1108 based on the inputs. The development status of the virtual agent is stored or updated at 1110.

At 1112, it is determined whether it is ready to integrate the program to generate the customized virtual agent. If so, the process goes to 1114, where program source codes are retrieved from a database based on visual inputs and/or the determined modules. Then the program codes are modified at 1116 based on a machine learning model. The modified program codes are integrated at 1118 to generate a customized virtual agent. The customized virtual agent is stored and sent at 1120 to the developer.

If it is determined at 1112 that it is not ready to integrate the program, the process goes to 1130, wherein the virtual agent modules are provided to the developer via the bot design programming interface. Then the process goes back to 1104 to receive further developer inputs.

It can be understood that the order of the steps shown in FIGS. 3, 5, 7 and 11 may be changed according to different embodiments of the present teaching.

FIG. 12 illustrates an exemplary bot design programming interface 1200 for a developer to specify conditions for triggering a task oriented dialog between a service virtual agent and a chat user, according to an embodiment of the present teaching. As shown in FIG. 12, the developer may specify various conditions for triggering the task dialog with, e.g. a weather virtual agent. In this example, a weather virtual agent will be triggered when a chat user says any of the following utterances: (a) What's the weather? 1202; (b) What's the weather like in San Jose? 1204; (c) How's the weather in San Jose? 1206; and (d) Is it raining in Cupertino? 1208. As discussed herein, the virtual agent development engine 170 may utilize machine learning to generate more utterances similar to those exemplary utterances, such that when a chat user says anything similar to the list of automatically generated utterances, a task oriented virtual agent may be triggered to assist the chat user by initiating a dialog with the chat user. Each task oriented virtual agent may carry on a dialog for gather information needed to serve the chat user. For example, a weather bot, once triggered, may need to ask the chat user information related to parameters for checking whether, such as locale, date, or even time.

In some situations, a chat user may pose a question with some parameters already embedded in a specific utterance. For example, utterance (b) above “What's the weather like in San Jose?” (1204) includes both word “weather” which can be used to trigger a weather virtual agent and “San Jose” which is a parameter needed by the weather virtual agent in order to check weather related information. According to the present teaching, “San Jose” may be identified as a city name from the utterance. With this known parameter extracted from the utterance, the weather virtual agent, once triggered no longer has the need to ask the chat user about the city name any more. Similar situations exist with respect to utterances (c) “How's the weather in San Jose?” (1206); and (d) “Is it raining in Cupertino?” (1208). It can be understood that a developer can specify different utterances for triggering a task oriented virtual agent.

FIG. 13A illustrates an exemplary bot design programming interface 1300 for a developer to select modules of a service virtual agent, according to an embodiment of the present teaching. As shown in FIG. 13A, the disclosed system can present a plurality of bot design graphical programming objects 1311-1318 available to a developer, via the bot design programming interface 1300. Each of the plurality of bot design graphical programming objects represents a module corresponding to an action or a sub-task to be performed by the virtual agent. According to various embodiments of the present teaching, the bot design graphical programming object 1311 represents “Information Collection” module which, once executed, causes the underlying virtual agent to take an action to collect information (from a chat user) needed for performing the task that the virtual agent is designed to perform. For example, if a weather virtual agent is being programmed, the first task of the weather virtual agent is to gather information needed to check weather information, e.g., city. Bot design graphical programming object 1312 represents a sub-task of “bot says” module which, once executed, causes a virtual agent to speak or present some utterances to a chat user. Bot design graphical programming object 1313 represents a module which, when executed, causes the virtual agent to execute an application or a service associated with the task that the virtual agent is to do. For example, a travel virtual agent may invoke Travelocity.com (an existing application or service) to get flights information. Bot design graphical programming object 1314 represents a module which, when executed, causes the virtual agent to insert an existing task that was previously developed for a different virtual agent or the current virtual agent. Bot design graphical programming object 1315 represents a module which, when executed, causes the virtual agent to escalate the chat user to a human agent or to a different virtual agent in a different channel such as live chat, email, phone, text messages, etc. Bot design graphical programming object 1316 represents a module which, when executed, causes the virtual agent to finish one task when the virtual agent is developed to execute a plurality of tasks. One example for that can be the following. If a virtual agent is for travel and can do both airline and hotel reservations. The travel virtual agent is capable of handling multiple tasks, some of which may involve other specialized virtual agents, e.g., an air travel virtual agent and a hotel virtual agent. In this case, each sub-virtual agent may handle some sub tasks but they all try to achieve the same goal—making full reservations for a chat user. Both sub-agents may need to gather information which may share a module to do so, e.g., collect chat user's name, dates of traveling, source and destinations, etc. At some point, one sub-agent (e.g., the air travel sub-agent) may have completed all the sub-tasks related thereto, even though the other sub-agent (e.g., the hotel sub-agent) may still operating to get the chat user's hotel reservation. At this point, the developer user may utilize bot design programming graphical object 1316 to wrap up the sub-task related to air travel by, e.g., ending the operation of the air travel sub-agent. This may allow the virtual agent to run more efficiently. However, without this function to end some sub-tasks may not affect the funcationality of the virtual agent.

Bot design graphical programming object 1317 represents a module which, when executed, causes the virtual agent to provide multiple options related to a parameter of a task or sub-task (e.g., if a chat user asks for means to travel to New York City, this module can be used to present “Travel by air or by bus?” and the answer to the question will allow the module to branch out to different sub-tasks). Bot design graphical programming object 1318 represents a module which, when executed, causes the virtual agent to execute a set of sub-modules or sub-tasks.

The developer can use such graphical bot design programming objects to quickly and efficiently program a virtual agent by arranging a sequence of actions to be performed by the virtual agent by simply dragging and dropping corresponding bot design graphical programming objects in a sequence. For example, as shown in FIG. 13A, the developer has selected a number of bot design graphical programming objects arranged in an order, i.e., a sequence of actions to be performed by the virtual bot currently being designed. In this example, the sequence of actions is represented by (1) action 1302 set up by dragging and dropping bot design graphical programming object 1311 to collect information, (2) action 1304 set up by dragging and dropping bot design graphical programming object 1312 for the virtual bot to speaks something to the chat user, (3) action 1306 set up by dragging and dropping bot design graphical programming object 1313 to invoke an action via a specific service (e.g., weather.com), and (4) action 1308 set up by dragging and dropping bot design graphical programming object 1312 for the virtual agent to speak to the chat user (e.g., report the weather information obtained from weather.com). This sequence of action correspond to a bot design with simple drag and drop activities to program the virtual bot with ease.

FIG. 13A illustrates an exemplary interface for development of a weather report virtual agent that can chat with any chat user about weather information. Specifically, the action of collecting information 1302, when executed, is to help to gather needed information from a chat user in order to provide the information the chat user is querying about. For example, the developer can make use of the collect information module 1302 to design how a chat bot is to collect information, e.g., the city to which a query about weather is directed.

FIG. 13B illustrates the exemplary bot design programming interface 1300 through which the developer can specify how a virtual agent can understand different ways to say the same thing. FIG. 13B corresponds to the same screen as what is shown in FIG. 13A but with a pull down list on to an answer to question “Which City?” In FIG. 13A, the answer to that question is “San Jose.” In FIG. 13B, a developer click on expand button 1332 (in FIG. 13A), which triggers a pull down list of different ways to answer “San Jose.” Once the expand button is clicked, the icon toggles to present a collapse button 1333 as shown in FIG. 13B. The developer may choose to add more alternatives to the list which can then be used by the virtual agent being programmed to understand an answer from a chat user. After the developer completes editing the list, the developer may click the collapse icon button 1333 to close the pull down list. As discussed before, the disclosed system deploy a deep learning model to identify an entity name from various sentences or text strings. In this example, although there are different ways to answer “San Jose” to a question on “Which city,” the deep learning model can be trained to recognize city name “San Jose” from all these various ways to say “San Jose.”

Referring back to FIG. 13A, the first “bot says” module 1304, when programmed into a virtual agent, allows the virtual agent to send an utterance to the chat user. For example, the developer can make use of the first “bot says” module 1304 to ask the chat user to be patient while the virtual agent is running some tasks. In this example, the weather virtual agent, after the chat user answers “San Jose,” the virtual agent may proceed to gather the weather information on San Jose and during that time, the weather virtual agent is programmed to use the first “bot says” module 1304 to let the chat user know the status by saying “Just a moment, searching for weather for you . . . ” In one embodiment, the developer may click the “add value” icon 1334 to enter a new utterance which can be used by the first “bot says” module 1304 as an alternative way to report the status to the chat user.

One such example is shown in FIG. 13C. FIG. 13C illustrates the exemplary bot design programming interface 1300 through which the developer may modify an existing utterance via the bot design programming interface to provide an alternative utterance for the first “bot says” module 1304 for the service virtual agent to be developed, according to an embodiment of the present teaching. As shown in FIG. 13C, the developer may click on the “Add value” icon 1334 (FIG. 13A) and enter an alternative utterance “The weather will be ready in a moment.” Once entered, the developer may click the icon 1335 for confirmation. In one embodiment, the confirmation may also be achieved when the developer hits the “enter” key on keyboard after entering the utterance. With the newly entered utterance, the first “bot says” module 1304, once being executed, may present the utterance to the chat user while the weather virtual agent is searching for the weather information for the city that the chat user specified.

Referring back to FIG. 13A, the application action module 1306, when executed, can invoke the virtual agent to execute an internal or external application or service. For example, the developer can make use of the application action module 1306 to interface with an external weather reporting service such as Yahoo! Weather to gather weather information for a specific city of a given date, or by running an embedded internal application, on weather related information gathering. In this example, based on chat user's input, the virtual agent may also generate warnings, e.g. a warning that city does not match with previous definition when the city provided by the chat user is not previously defined; or a warning that date has not been collected, when the virtual agent does not have the information about the date for the weather search.

It can be understood that a virtual agent may be programmed quickly with ease using the present teaching. Not only different modules may be used to program a virtual agent but also different virtual agents for the same task may be programmed using different sequences of modules. All may be done by easy drag and drop activities with possible additional editing to the parameters used by each module. A same module can be repeatedly used within a virtual agent, e.g. the first “bot says” module 1304 and the second “bot says” module 1308 in FIG. 13A. It can also be understood that, when the developer drags and drops a bot design graphical programming object to a specific position in a sequence in the bot design programming interface, the developer implicitly specifies an order for the modules in the sequence. For example, since the developer puts the first “bot says” module 1304 after the “collect information” module 1302 and before the application action module 1306, the first bot says module 1304 will be executed by the virtual agent after the “collect information” module 1302 and before the “application action” module 1306. As shown in FIG. 13A, each module has been listed according to the order when it will be executed by the virtual agent.

As shown in FIG. 13A, although a module may be executed without any condition (or unconditionally), the developer may also set a condition under which the module is to be executed. For example, as shown, the developer may set a condition for executing the application action module 1306, e.g., the application action module 1306 will only be executed when all parameters, e.g. city, date, etc. have been collected from the chat user. In another example, the developer may set a condition that an action to escalate a chat user to a human agent via an escalation module until the conversation with the chat user is involved with a price that is higher than a threshold or when the chat user is detected to be dissatisfied with the virtual agent.

In one embodiment, the disclosed system can present a button “Chat with Virtual Assistant” 1320 on the bot design programming interface. In this example, once the developer clicks on the button 1320, the disclosed system may allow the developer to test the virtual agent just programmed in accordance with the sequence of modules (put together by drag and drop various bot design graphical programming objects) by starting a dialog with the programmed virtual agent. With this functionality, the developer may program, test, and modify the virtual agent repeatedly until the virtual agent can be deployed as a functionally customized virtual agent.

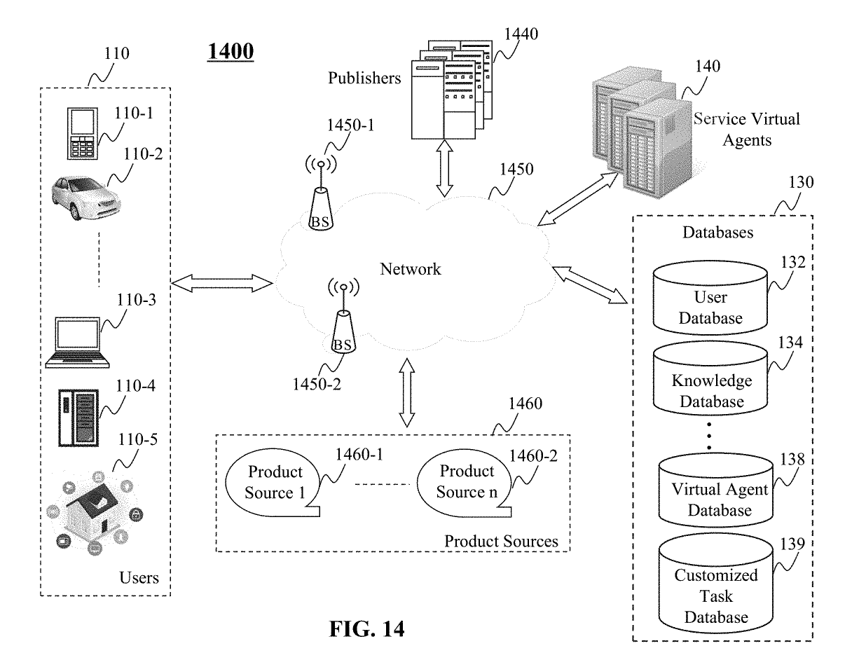

FIG. 14 is a high level depiction of an exemplary networked environment 1400 for development and applications of service virtual agents, according to an embodiment of the present teaching. In this exemplary networked environment 1400, user 110 may be connected to a publisher 1440 via the network 1450. There are additional product sources 1460 where a plurality of products sources 1460-1 . . . 1460-2 that the user may be connected to and be able to search for products via conversations with the service virtual agents 140 as disclosed herein. A user can be operating from different platforms and in different type of environment such as on a smart device 110-1, in a car 110-2, on a laptop 110-3, on a desktop 110-4 . . . , or from a smart home 110-5. The network 1450 may include wired and wireless networks, including but not limited to, cellular network, wireless network, Bluetooth network, Public Switched Telephone Network (PSTN), the Internet, or any combination thereof. For example, a user device may be wirelessly connected via Bluetooth to a cellular network, which may subsequently be connected to a PSTN, and then reach to the Internet. The network 1450 may also include a local network (not shown), including a LAN or anything that is set up to serve equivalent functions.

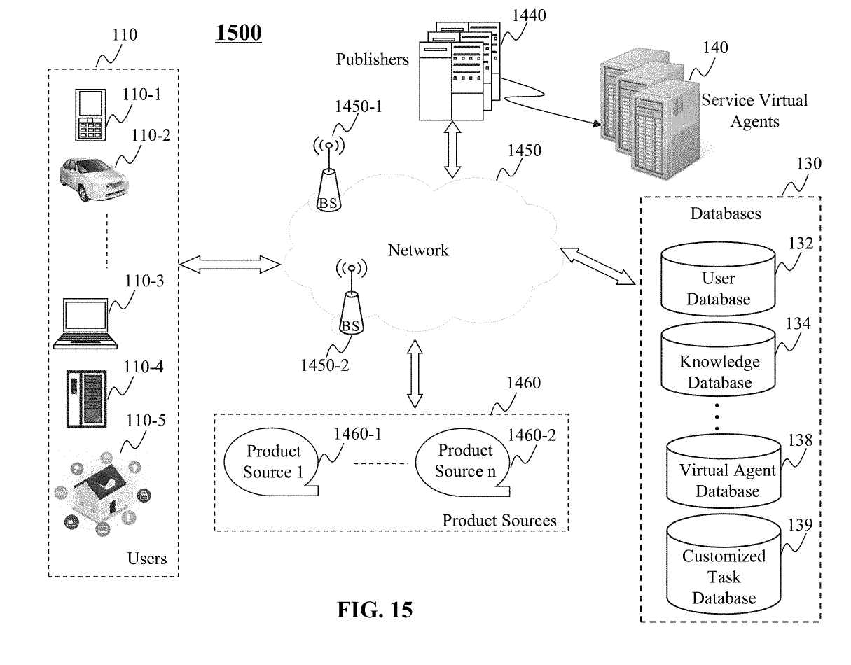

In FIG. 14, each of the service virtual agents 140 are connected to the network 1450 to provide the functionalities as described herein, either independently as a standalone service, as depicted in FIG. 14, or as a backend service provider connected to the publisher 1440 as shown in FIG. 15 or to any of the product sources (not shown) as a backend specialized functioning support for the product source. Various databases 130 (including but not limited to a user database 132, a knowledge database 134, a virtual agent database 138, . . . , and a customized task database 139) may also be made available, either as independent sources of information as shown in FIGS. 14 and 15 or as backend databased in association with the service virtual agents 140 (not shown).

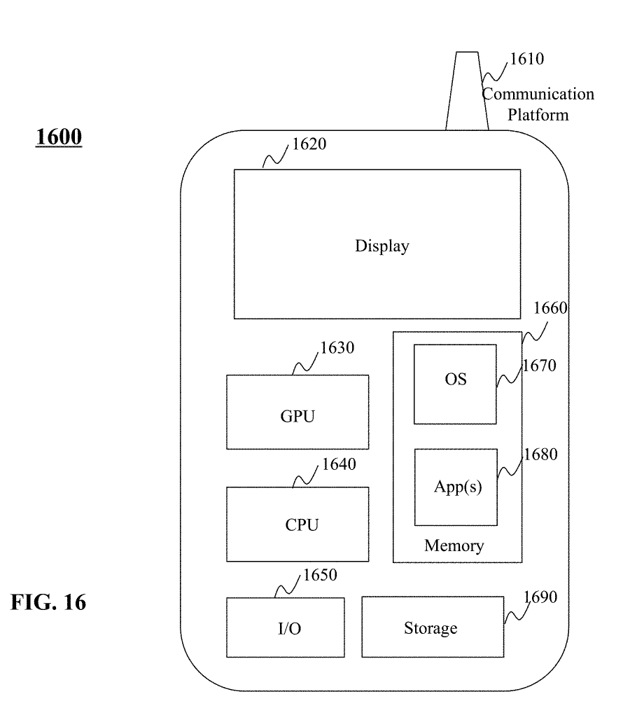

FIG. 16 depicts the architecture of a mobile device which can be used to realize a specialized system implementing the present teaching. This mobile device 1600 includes, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 1600 in this example includes one or more central processing units (CPUs) 1640, one or more graphic processing units (GPUs) 1630, a display 1620, a memory 1660, a communication platform 1610, such as a wireless communication module, storage 1690, and one or more input/output (I/O) devices 1650. Any other suitable component, including but not limited to a system bus or a controller (not shown), may also be included in the mobile device 1600. As shown in FIG. 16, a mobile operating system 1670, e.g., iOS, Android, Windows Phone, etc., and one or more applications 1680 may be loaded into the memory 1660 from the storage 1690 in order to be executed by the CPU 1640.

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to the present teachings as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

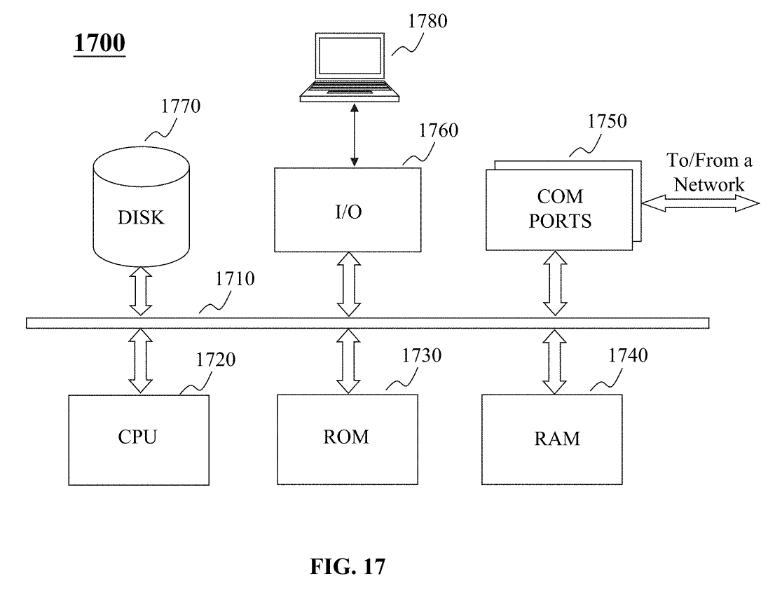

FIG. 17 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 1700 may be used to implement any component of the present teachings, as described herein. Although only one such computer is shown, for convenience, the computer functions relating to the present teachings as described herein may be implemented in a distributed fashion on a number of similar platforms, to distribute the processing load.

The computer 1700, for example, includes COM ports 1750 connected to and from a network connected thereto to facilitate data communications. The computer 1700 also includes a central processing unit (CPU) 1720, in the form of one or more processors, for executing program instructions. The exemplary computer platform includes an internal communication bus 1710, program storage and data storage of different forms, e.g., disk 1770, read only memory (ROM) 1730, or random access memory (RAM) 1740, for various data files to be processed and/or communicated by the computer, as well as possibly program instructions to be executed by the CPU. The computer 1700 also includes an I/O component 1760, supporting input/output flows between the computer and other components therein such as user interface element. The computer 1700 may also receive programming and data via network communications.

Hence, aspects of the methods of the present teachings, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of a search engine operator or other enhanced ad server into the hardware platform(s) of a computing environment or other system implementing a computing environment or similar functionalities in connection with the present teachings. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the present teachings as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on a computer having at least one processor, a storage, and a communication platform for developing a virtual agent, comprising:
presenting, via a bot design programming interface, a plurality of graphical objects to a developer user, wherein each of the plurality of graphical objects represents a module which, once executed, performs an action;
receiving, via the bot design programming interface, one or more inputs from the developer user that selects a set of graphical objects from the plurality of graphical objects and provides information about an order in which the set of graphical objects is organized;
identifying a set of modules represented by the set of graphical objects;
integrating the set of modules in the order to generate the virtual agent which, when deployed, performs actions corresponding to the set of modules in the order.

2. The method of claim 1, further comprising receiving information from the developer user requesting customization of at least one of the set of modules, wherein
for each of the at least one of the plurality of modules,
determining at least one parameter which can be customized,
obtaining at least one input from the developer user directed to each of the at least one parameter, and
automatically modifying the module based on the at least one input directed to each of the at least one parameter and/or additional input obtained based on a machine learning model to generate a modified module, wherein
the step of integrating includes integrating one or more modified modules in place of their corresponding unmodified modules.

3. The method of claim 2, wherein the at least one input from the developer user comprises at least one of:
a selection of the at least one parameter; and
information provided by the developer user associated with a specific state related to any one of the at least one parameter.

4. The method of claim 2, wherein the at least one parameter includes a condition upon which an action corresponding to the module is to be performed.

5. The method of claim 1, further comprising:
receiving, via the bot design programming interface, one or more forms of representing an utterance as a triggering condition to initiate a dialog between a chat user and the virtual agent.

6. The method of claim 1, further comprising presenting, via the bot design programming interface:
a first means through which the developer user is able to initiate a dialog with the virtual agent for testing;
a second means through which the developer user is able to further customize any of the set of modules to generate an updated virtual agent; and
a third means through which the developer user is able to deploy the virtual agent.

7. The method of claim 1, wherein at least some of the plurality of graphical objects represent modules for:
collecting information from a chat user during a dialog with the virtual agent;
sending one or more utterances to the chat user;
executing an application associated with the module wherein the application is related to the task to be performed by the module represented by a graphical object;
inserting an existing task previously developed;
escalating the chat user to one of a human agent and a different virtual agent;
providing multiple options associated with a parameter related to a module; and
executing a sub-task upon the chat user's selection of one of the multiple options.

8. The method of claim 1, wherein
the virtual agent is generated for a specific task; and
each of the set of modules integrated to form the virtual agent performs a sub-task associated with the specific task.

9. The method of claim 8, further comprising:
storing the virtual agent as a template; and
presenting to a different developer user as the basis for developing a different virtual agent intended for a task similar to the specific task.

10. Machine readable and non-transitory medium having information recorded thereon for developing a virtual agent, wherein the information, when read by the machine, causes the machine to perform the following:
presenting, via a bot design programming interface, a plurality of graphical objects to a developer user, wherein each of the plurality of graphical objects represents a module which, once executed, performs an action;
receiving, via the bot design programming interface, one or more inputs from the developer user that selects a set of graphical objects from the plurality of graphical objects and provides information about an order in which the set of graphical objects is organized;
identifying a set of modules represented by the set of graphical objects;
integrating the set of modules in the order to generate the virtual agent which, when deployed, performs actions corresponding to the set of modules in the order.

11. The medium of claim 10, wherein the information, when the information is read by the machine, further causes the machine receiving information from the developer user requesting customization of at least one of the set of modules, wherein
for each of the at least one of the plurality of modules,
determining at least one parameter which can be customized,
obtaining at least one input from the developer user directed to each of the at least one parameter, and
automatically modifying the module based on the at least one input directed to each of the at least one parameter and/or additional input obtained based on a machine learning model to generate a modified module, wherein
the step of integrating includes integrating one or more modified modules in place of their corresponding unmodified modules.

12. The medium of claim 11, wherein the at least one input from the developer user comprises at least one of:
a selection of the at least one parameter; and
information provided by the developer user associated with a specific state related to any one of the at least one parameter.

13. The medium of claim 11, wherein the at least one parameter includes a condition upon which an action corresponding to the module is to be performed.

14. The medium of claim 10, wherein the information, when the information is read by the machine, further causes the machine receiving, via the bot design programming interface, one or more forms of representing an utterance as a triggering condition to initiate a dialog between a chat user and the virtual agent.

15. The medium of claim 10, wherein the information, when the information is read by the machine, further causes the machine presenting, via the bot design programming interface:
a first means through which the developer user is able to initiate a dialog with the virtual agent for testing;
a second means through which the developer user is able to further customize any of the set of modules to generate an updated virtual agent; and
a third means through which the developer user is able to deploy the virtual agent.

16. The medium of claim 10, wherein at least some of the plurality of graphical objects represent modules for:
collecting information from a chat user during a dialog with the virtual agent;
sending one or more utterances to the chat user;
executing an application associated with the module wherein the application is related to the task to be performed by the module represented by a graphical object;
inserting an existing task previously developed;
escalating the chat user to one of a human agent and a different virtual agent;
providing multiple options associated with a parameter related to a module; and
executing a sub-task upon the chat user's selection of one of the multiple options.

17. The medium of claim 1, wherein
the virtual agent is generated for a specific task; and
each of the set of modules integrated to form the virtual agent performs a sub-task associated with the specific task.

18. The medium of claim 17, wherein the information, when the information is read by the machine, further causes the machine
storing the virtual agent as a template; and
presenting to a different developer user as the basis for developing a different virtual agent intended for a task similar to the specific task.

19. A system for developing a virtual agent, comprising:
a bot design programming interface manager configured for
presenting, via a bot design programming interface, a plurality of graphical objects to a developer user, wherein each of the plurality of graphical objects represents a module which, once executed, performs an action, and
receiving, via the bot design programming interface, one or more inputs from the developer user that selects a set of graphical objects from the plurality of graphical objects and provides information about an order in which the set of graphical objects is organized;
a virtual agent module determiner configured for identifying a set of modules represented by the set of graphical objects; and
a visual input based program integrator configured for integrating the set of modules in the order to generate the virtual agent which, when deployed, performs actions corresponding to the set of modules in the order.

20. The system of claim 19, wherein
the virtual agent module determiner is further configured for receiving information from the developer user requesting customization of at least one of the set of modules, wherein
for each of the at least one of the plurality of modules, the virtual agent module determiner is configured for
determining at least one parameter which can be customized, and
obtaining at least one input from the developer user directed to each of the at least one parameter; and
the visual input based program integrator is further configured for:
automatically modifying the module based on the at least one input directed to each of the at least one parameter and/or additional input obtained based on a machine learning model to generate a modified module, wherein
the visual input based program integrator integrates one or more modified modules in place of their corresponding unmodified modules.

21. The system of claim 20, wherein the at least one input of the developer user comprises at least one of:
a selection of the at least one parameter; and
information provided by the developer user associated with a specific state related to any one of the at least one parameter.

22. The system of claim 20, wherein the at least one parameter includes a condition upon which an action corresponding to the module is to be performed.

23. The system of claim 19, further comprising a developer input processor configured for receiving, via the bot design programming interface, one or more forms of representing an utterance as a triggering condition to initiate a dialog between a chat user and the virtual agent.

24. The system of claim 19, wherein the bot design programming interface manager is further configured for presenting
a first means through which the developer user is able to initiate a dialog with the virtual agent for testing;
a second means through which the developer user is able to further customize any of the set of modules to generate an updated virtual agent; and
a third means through which the developer user is able to deploy the virtual agent.

25. The system of claim 19, at least some of the plurality of graphical objects represent modules for:
collecting information from a chat user during a dialog with the virtual agent;
sending one or more utterances to the chat user;
executing an application associated with the module wherein the application is related to the task to be performed by the module represented by a graphical object;
inserting an existing task previously developed;
escalating the chat user to one of a human agent and a different virtual agent;
providing multiple options associated with a parameter related to a module; and
executing a sub-task upon the chat user's selection of one of the multiple options.

26. The system of claim 19, wherein:
the virtual agent is generated for a specific task; and
each of the set of modules integrated to form the virtual agent performs a sub-task associated with the specific task.

27. The system of claim 26, wherein
the visual input based program integrator is further configured for storing the virtual agent as a template; and
the bot design programming interface manager is further configured for presenting to a different developer user as the basis for developing a different virtual agent intended for a task similar to the specific task.
